(19) United States
(12) Patent Application Publication
(10) Pub. No.: US 2002/0114309 A1
(43) Pub. Date: Aug. 22, 2002

(54) Resource allocation for channels in wireless networks

(75) Inventors: Jocelyn Chow, Nepean (CA); Christopher Lau, Calgary (CA)

Correspondence Address: SMART & BIGGAR, Suite 1500, Box 111, 438 University Avenue, Toronto, ON, M5G 2K8, CA

(73) Assignee: NORTEL NETWORKS LIMITED

(21) Appl. No.: 09/746,198

(22) Filed: Dec. 26, 2000

(51) Int. Cl. H04B 7/212

(52) U.S. Cl. 370/347; 370/337

(57) ABSTRACT

Embodiments of the present invention organize a collection of data frames which can be allocated to mobilestations into sets of contiguous groups of frames Each group of frames is mutually independent in time (i.e., each group of contiguous frames does not overlap, in time, with another group of contiguous frames). Each orthogonal group of frames is assigned to a BS (a single BS may be assigned more than one orthogonal group of frames). The BS may allocate its assigned orthogonal group of frames to a plurality of MSs thus forming a plurality of communications channels. In a further embodiment, a single BS, having been assigned more than one orthogonal group of frames, can assign each orthogonal group of frames to sectors (or sections) within a wireless cell.

### FIELD OF THE INVENTION

The present invention relates to the allocation of resources in wireless networks and, more particularly, to the allocation of resources to basestations and mobilestations in wireless networks.

### BACKGROUND TO THE INVENTION

During the past several years, there has been a tremendous increase in the use of wireless communication services. Initially, this increased use was fuelled by increases in wireless voice communications. However, recently, the adoption of digital wireless networks has resulted in further increased usage due to non-voice data transmissions. These non-voice data transmissions have been used to send and receive e-mail, files (e.g., HTML, XML, etc.) or the like. Additionally, users of wire based networks have become accustomed to the services provided by these wire based networks (e.g., stock quotes, travel sites, e-commerce, etc.) and have started to demand that the same services be made available using wireless networks. As persons of ordinary skill in the art will appreciate, this increased use (due to increases in both voice and non-voice communications) has strained the wireless networks and resulted, in some instances, in a lack of availability of wireless network resources (e.g., bandwidth, or, in the Time Division Multiple Access—TDMA—regime, timeslots).

Unfortunately, for the purpose of global roaming for mobile terminals, this increased demand for wireless services has been further complicated by the various types of wireless networks currently in use coupled with service providers' desire to leverage (rather than replace) their current infrastructure. That is, while many people consider that most wireless networks will eventually employ the Global System for Mobile communications (GSM) standard, current wireless network providers (i.e., carriers) currently employing differing standards (e.g., TDMA) are unable or unwilling to simply “scrap” the present systems so that a GSM network can be deployed.

As a result of these difficulties, present carriers (both TDMA and GSM) have aligned to develop the Enhanced Data rates for Global Evolution (EDGE) standard (and a less robust version known as EDGE Compact). The EDGE and EDGE Compact standards have been submitted to the International Telecommunication Union (ITU).

The EDGE Compact standard defines, in part, a common air interface which interoperates with both TDMA and GSM networks. The EDGE air interface supports high speed data and packet data architectures promising data rates of up to 384 kilobits per second (kbps).

However, the proposed EDGE Compact standard is not without problems. For example, it is known that the frequency reuse strategy employed is very aggressive. A stylised typical network 100 (shown in FIG. 1) illustrates that non-contiguous cells 102A-102N can use (or re-use) the same frequencies with tolerable interference. The distance between cells which use the same frequencies is identified by the variable “D”. The following equation generally holds:

$$\frac{D}{R} = \sqrt{3 N}$$

where R is the cell radius and N is the reuse pattern (i.e., the number of cells in cluster of cells making up the pattern).

As indicated above, EDGE compact is very aggressive in its reuse strategy indicating that D is relatively small. A low reuse pattern (N) (e.g., three or less) is considered to be an aggressive strategy while a high value (e.g., seven or greater) is considered to be relatively non-aggressive.

An aggressive strategy is employed under the EDGE Compact standard, due to the smaller bandwidth employed as specified by the EDGE Compact standard. Hence, a smaller number of carrier frequencies is available resulting in a smaller value for N, the number of cells in a cluster. As a consequence of this aggressive reuse, the carrier to interference ratio (C/I) is lower in comparison to that for a GSM system (i.e., for a given carrier signal strength, the amount of interference increases). C/I can be defined

$$C / I = \frac{C}{{\sum }_{k = 1}^{{k}_{I}} {I}_{k}}$$

where C is carrier or signal power, and kₗ is the number of co-channel interfering cells (see Black, Ulysses, Mobile and Wireless Networks, Prentice-Hall, 1996, the contents of which are hereby incorporated herein by reference).

As a result of the aggressive reuse strategy in EDGE compact, the C/I ratio is poor and often does not permit reliable data transmission on TDMA traffic timeslots.

It has been suggested that rotational timegroups be employed to increase the C/I ratio. This strategy has been employed with respect to the control channels. Control channels are used to transmit signalling information relating to control the wireless network and data channels used transmit data (e.g., voice). However, this rotational timegroup strategy has proved to be unsuitable for application to packet traffic channels.

The rotational timegroup solution used for control channels employs the organization of bitmap 200 illustrated in FIG. 2.

Bitmap 200 of FIG. 2 (which has been simplified for exemplary purposes only) includes twenty-four sequential data frames 210—each data frame comprising eight time slots 204. A timeslot 204 in one or more data frames 210 in a bitmap 200 is assigned for use for communications between mobilestations (MSs) serviced by a selected basestation (BS).

In the rotational timegroup solution used with control channels, a Mobile Telephone Switching Office (MTSO) 108 (FIG. 1A), divides a single bitmap 200 into four timegroups (tg1, tg2, tg3 and tg4). Each timegroup (tg) includes a pair of timeslots 204 in all twenty-four data frames 210 in a given bitmap. Each timegroup will be assigned by the MTSO to one BS selected from a group of BSs which use the same frequencies in a cluster of cells. Timeslots within a control channel timegroup are designated as Packet Broadcast Control Channels, Packet Common Control Channels, etc. These packet control channels in UL and DL control channel timegroups are used by an MS and the assigning BS to exchange UL and DL control information.

When applying the scheme of rotational timegroups to traffic or data packet channels, each BS, having been allocated the resources of a timegroup, sub-divides the timegroup and allocates sub-divided portions of the timegroup to those MSs requesting resources. Using the rotational timegroup solution, and for a given data frame 210 in a bitmap 200, a first BS allocated resources in the first timegroup (tg1) will communicate first (i.e., the first BS will communicate using timeslots 0 and 1 of the first TDMA frame). After the time spanned by timeslots 0 and 1 in the first TDMA frame, the first BS will cease communications allowing a second BS allocated resources in the second timegroup (tg2—timeslots 2 and 3 in the first TDMA frame) to communicate. After the second BS has ceased communicating, a third BS, allocated resources in the third timegroup (tg3—timeslots 4 and 5 in the first TDMA frame) will communicate. The third BS, after ceasing communications, will be followed by a fourth BS having been allocated resources in the fourth timegroup (tg4—timeslots 6 and 7 in the first TDMA frame). The pattern will then repeat for following data frames 210. Each of the four BSs use the same frequency.

Unfortunately, the rotational timegroup solution used for control channels imposes an allocation scheme that results in inefficiencies in allocating the wireless resources for data communication and limitations on the types of mobilestations that can be supported under the rotational timegroup scheme.

For example, standards dictate that a maximum of eight MSs can be assigned in a timeslot serviced by a single BS. Consequently, a BS implementing the rotational timegroup solution for data channels will be limited to servicing a maximum of sixteen MSs on a single RF carrier since a maximum of two timeslots are allocated to any one BS. This is an unnecessary limitation to the specified capacity of thirty-two MSs permitted by the GSM standards. Additionally, the strict structure of the rotational timegroup solution places severe restrictions in the type of resource allocation scheme that can be employed to efficiently allocate the resources (i.e., data frames 210 of bitmap 200) to mobilestations. For example, the use of timegroups dictates that a maximum of 2 timeslots can be assigned to mobiles even though a multislot mobile is able to support up to 8 timeslots.

Accordingly, it would be desirable to provide a scheme to allocate wireless resources in a wireless network which addresses some of these shortcomings.

### SUMMARY OF THE INVENTION

Advantageously, embodiments of the present invention organize a bitmap (a collection of data frames which can be allocated to mobilestations) into sets of contiguous “sub-bitmaps” or groups of frames. Each sub-bitmap is mutually independent in time (i.e., each group of contiguous frames does not overlap, in time, with another group of contiguous frames in the bitmap—hereinafter “orthogonal sub-bitmaps” or “sub-bitmap”). Each orthogonal sub-bitmap of the larger bitmap is assigned to a BS (a single BS may be assigned more than one orthogonal sub-bitmap in a single bitmap). The BS may allocate timeslots with its assigned orthogonal sub-bitmap to a plurality of MSs thus forming a plurality of communications channels. Since a sub-bitmap may span across the full TDMA frame of timeslots (e.g., eight timeslots), a BS is not as limited in the number of MSs that can be serviced (as compared to the rotational timegroup solution). Further, embodiments of the invention impose fewer boundary constraints (as compared to the rotational timegroup solution) on the scheme for allocating resources on both an MTSO and a BS. Consequently, more flexible allocation schemes can be employed by either an MTSO or a BS.

Additionally, further advantages of embodiments of the present invention are recognized when reassigning frames from one sub-bitmap belonging to one BS to another sub-bitmap belonging to another BS. In this circumstance, embodiments of the present invention do not require, for each BS, the reassignment of timeslots for mobiles with active TBFs. In contrast, when timegroups are reassigned, it is required for each BS that active TBFs on those timegroups be terminated and that new timeslots be assigned to those mobiles.

In a further embodiment, a single BS, having been assigned more than one orthogonal sub-bitmap, can assign each sub-bitmap to sectors (or sections) within a wireless cell.

Alternative embodiments of the invention may combine the orthogonal sub-bitmap concept with the allocation of carrier frequencies to further increase the effective reuse distance (D).

Embodiments of the invention may include use of omni-directional antennas using one carrier per cell, omni-directional antennas with more than one (e.g., three) carriers per cell or sectorized antennas.

In one aspect of the invention there is provided a method of allocating a plurality of data frames amongst a plurality of basestations, said plurality of data frames spanning an interval of time, said method comprising: for each of said plurality of basestations allocating a sub-set of said plurality of data frames, said sub-set being contiguous in time within said interval of time.

In a further aspect of the invention there is provided a method of allocating a bitmap of resources in a wireless network amongst a plurality of co-channel basestations, said bitmap formed by a group of data frames, said method comprising: dividing said bitmap of resources into sub-bitmaps, each of said sub-bitmaps formed by a contiguous portion of said group of data frames, each of said sub-bitmaps not overlapping in time with any other of said sub-bitmaps; and allocating at least one of said sub-bitmaps to each of said plurality of co-channel basestations.

In a further aspect of the invention there is provided a basestation in a wireless cell, said basestation comprising: a processing circuit in communication with memory storing computer readable instructions, said computer readable instructions adapting said processing circuit to: receive instructions indicating a time period during which said basestation may communicate with mobilestations to be serviced by said basestation, said time period defined by a contiguous set of data frames; and transmit to each of said mobilestations to be serviced by said basestation data identifying a portion of time during which a mobilestation may communicate with said basestation; and communicate with said mobilestations during said time period.

In a further aspect of the invention there is provided a method of allocating wireless network resources amongst a plurality of basestations, said wireless network resources comprising a group of data frames, said method comprising: receiving requests for wireless network resources from said plurality of basestations; responsive to said requests, assigning to each of said plurality of basestations a portion of said wireless resources, said portion comprising a group of said data frames, said group of said frames being contiguous in time.

In a further aspect of the invention there is provided a method for coordinating operation of a plurality of basestations, each of said basestations operating with the same carrier frequency, said method comprising: for a given time period, allocating a contiguous portion of said given time period to each of said plurality of basestations; and transmitting to each of said plurality basestations data identifying said contiguous portion of said given time period allocated to a basestation.

In a further aspect of the invention there is provided a computer readable medium operable to provide instructions for directing a processor circuit to allocate a bitmap of resources in a wireless network amongst a plurality of co-channel basestations, said bitmap formed by a group of data frames, said instructions directing said processing circuit to: divide said bitmap of resources into sub-bitmaps, each of said sub-bitmaps formed by a contiguous portion of said group of data frames, each of said sub-bitmaps not overlapping in time with any other of said sub-bitmaps; and allocating at least one of said sub-bitmaps to each of said plurality of co-channel basestations.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The present invention will be more clearly understood with reference to the following detailed description read in conjunction with the drawings, in which:

FIG. 1 is a schematic of a wireless network;

FIG. 1A is a schematic of a portion of the wireless network of FIG. 1;

FIG. 1B is a schematic of a portion of a basestation forming part of the wireless network of FIG. 1;

FIG. 2 illustrates rotational time groups organization of timeslot wireless resources;

FIG. 2A is a schematic of an exemplary grouping of data frames used by embodiments of the invention;

FIG. 3 illustrates an organization of timeslots of wireless resources according embodying one aspect of the present invention; and

FIG. 4 illustrates a collection of wireless cells employing, in part, the timeslot organization of FIG. 3.

### DETAILED DESCRIPTION OF THE PREFERRED EMBODIMENTS

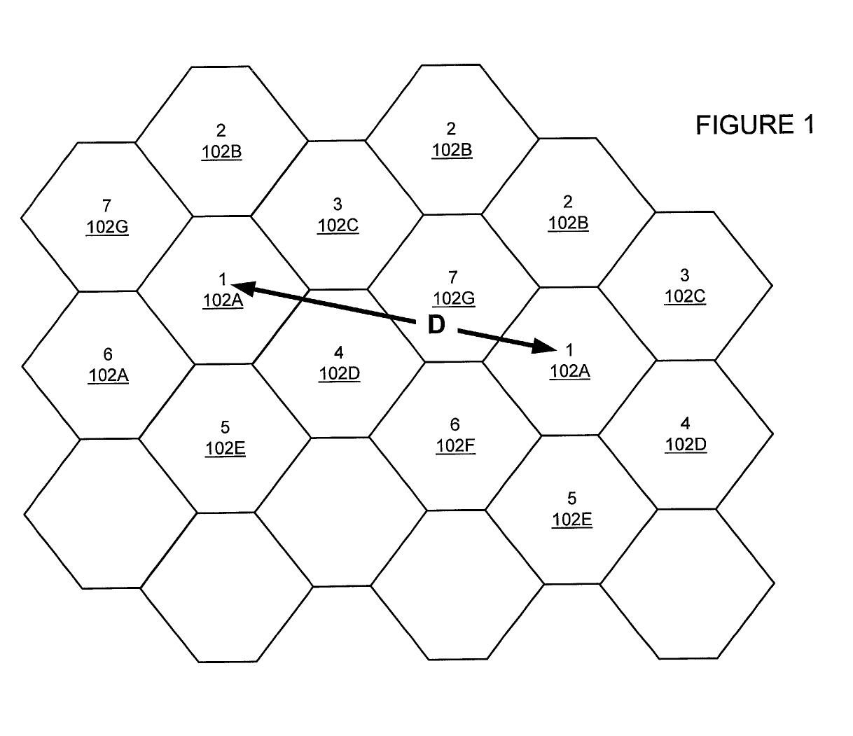

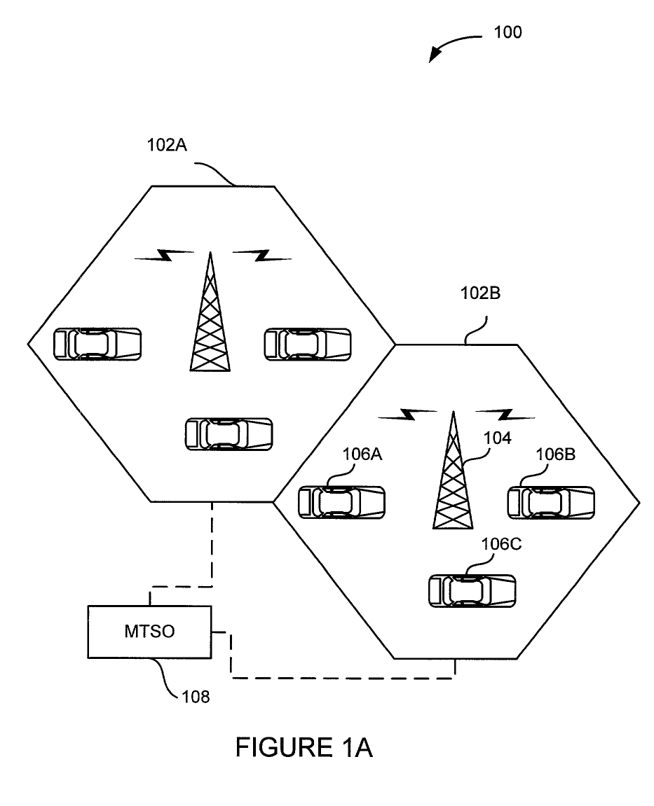

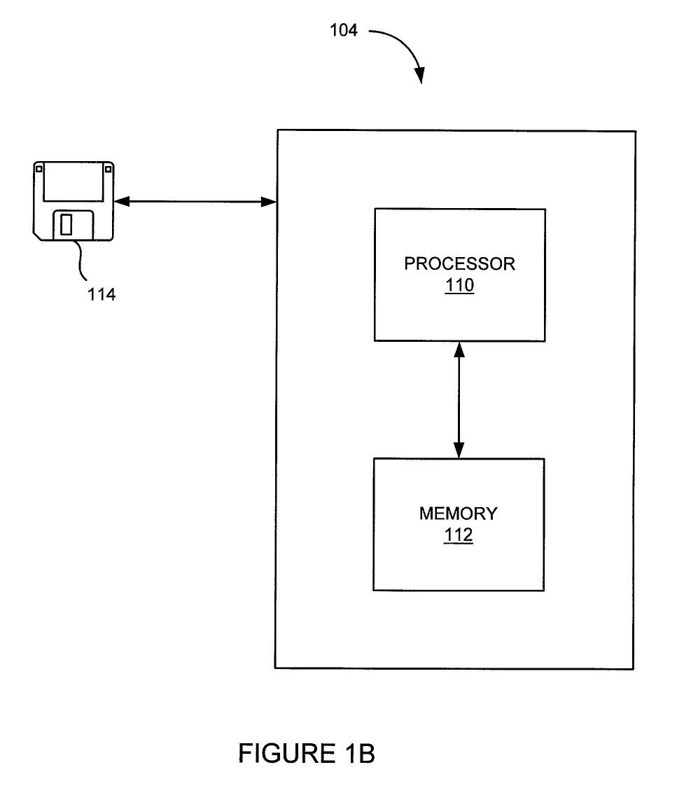

As indicated above with reference to FIG. 1, a wireless network 100 includes a plurality of cells 102 that are arranged in a pattern (while the hexagonal shape is used to represent cells, this stylized representation is not accurate—the actual shape of a cell depends upon many different factors).

Two cells 102A, 102B are illustrated in greater detail in FIG. 1A. Each cell 102 includes a BS 104 which services a plurality of MS 106. As known in the art, an MS 106 may move between cells during a single communications session (e.g., a wireless voice call). Each BS 104 communicates with MTSO 108. MTSO 108 communicates with and coordinates the basestations in a region.

Wireless network 100 in the described embodiment is a TDMA network which also operates to use the EDGE or EDGE Compact standard. A virtual channel (i.e., an uplink (UL) or downlink (DL) temporary block flow (TBF)) between an MS 106, such as MS 106A, and a BS (e.g., BS 104A) is formed by one or more timeslots in a series of TDMA frames (detailed in Principles and Applications of GSM by Vijay Kumar Garg and Joseph E. Wilkes, Prentice-Hall, 1999, ISBN 0-13-949124-4, the contents of which are incorporated herein by reference).

The UL TBF is wherein data is transferred from the MS to the BS and the DL is the reverse. TBFs for UL and DL are considered to be independent distinct transfers.

Each BS 104 (shown in greater detail in FIG. 1B) may include a processing circuit 110 which can be adapted to perform the operations described herein by retrieval of computer instructions or codes from a storage medium such as memory 112 or removable or distant computer readable medium 114. Computer medium 114 may be, for example, a diskette, flash memory, CD-ROM, remote computer or the like.

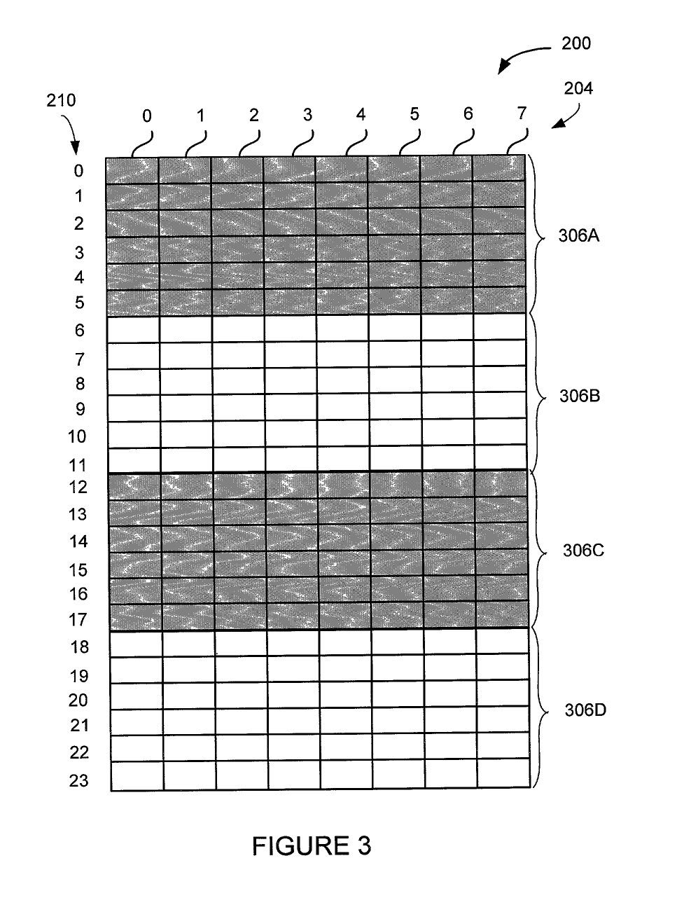

Referencing FIG. 3, embodiments of the present invention divide a bitmap 200 into four separate and, as will be discussed in greater detail below, time independent sub-bitmaps 306A, 306B, 306C, 306D (collectively and individually sub-bitmaps 306). Each sub-bitmap 306 may then be assigned by an MTSO 108 to a BS 104. The sub-bitmaps 306 of a single bitmap 200 will be assigned to BSs 104 which use the same carrier frequency (e.g., the sub-bitmaps 306 are assigned to co-channels cells). A BS 104 may be informed of the sub-bitmap 306 assigned through messages transmitted using DL control channels. Each BS 104 is then free to allocate the resources in the assigned sub-bitmap(s) 306 as required to establish and maintain data communication with any serviced MSs 106. As is known by those of ordinary skill in the art, an MS 106 will be informed by its servicing BS 104 as to which resources (i.e., which timeslots 204) have been allocated to the MS 106 for use. The MS 106 will then transmit/receive data during the allocated timeslots within data frames 210 in sub-bitmaps.

In operation, an MS 106 requests wireless resources (i.e., one or more timeslots) from a BS 104 so that a channel between the MS 106 and a third party can be established. The third party may, for example, be another MS—in the same or a different cell; a wired station, such as a conventional telephone handset; a web or data server; a computer; or the like. Responsive to this request, BS 104 allocates sufficient wireless resources to allow MS 106 to commence two-way communications (using the UL and DL TBFs) with the third party—the resources allocated form part of the UL and DL sub-bitmaps 306 assigned to the BS 104 by MTSO 108. The resources allocated to the MS 106 are used to establish both an UL TBF (from MS 106 to BS 104) and a DL TBF (from BS 104 to MS 106) on the UL bitmap carried by the UL frequency and on the DL bitmap carried by the DL frequency respectively. Once resources have been allocated, communications, which may include voice and/or data, between the MS 106 and the third party can proceed.

Generally, a BS 104 will operate using two frequencies: the first frequency is used for UL packet data communication channels; the second frequency is used for DL packet data communication channels. Both frequencies are used to establish/maintain both the UL and DL communication channels. Accordingly, a BS 104 will, generally, be assigned at two sub-bitmaps 306, one from the UL bitmap carried by the UL frequency and one from the DL bitmap carried by the DL frequency. A first sub-bitmap 306 from a first UL bitmap 200 will be allocated by the BS 104 exclusively for UL packet data communications. A first sub-bitmap from a first DL bitmap 200 will be allocated by the BS 104 exclusively for DL packet data communications. The BS 104 allocates the resources for UL and DL communications independently.

As the resources for each bitmap 200 associated with the UL and DI frequencies respectively are assigned and then consumed/used, MTSO 108 assigns additional sub-bitmaps 306 to the BSs 104 from subsequent bitmaps 200 on each carrier frequency.

As will be appreciated by those of ordinary skill in the art, bitmap 200 may be divided into any number of sub-bitmaps 306 (in the exemplary embodiment, four such sub-bitmaps are illustrated). Additionally, there is no requirement that each sub-bitmap be similarly sized (e.g., a first sub-bitmap may include six data frames (48 timeslots) while another sub-bitmap forming part of the same bitmap 200 may include a different number of data frames). Additionally, a selected BS 104 may be assigned different sub-bitmaps 306 (which may also be of different sizes) in different bitmaps 200. For example, in a first bitmap 200 a selected BS 104 may be assigned sub-bitmap 306C. In the next bitmap 200, the same BS 104 may be assigned sub-bitmap 306D. Sub-bitmaps 306C and 306D may be of different sizes (i.e., have different number of data frames 210).

As will be appreciated by those of ordinary skill in the art, the data frames 210 which form a sub-bitmap 306 are contiguous with respect to time. That is, the data frames 210 which form the sub-bitmap 306 follow each other and are not interrupted by data frames 210 assigned to another sub-bitmap 306. Additionally, each sub-bitmap 306 includes the full complement (i.e., eight) timeslots 204 for each data frame 210 assigned.

According to the GSM standard (described in General Packet Radio Service Mobilestation-Basestation Interface; Radio-link Control/Medium Access Control Protocol, GSM 04.60, Version 8.6.0 published European Telecommunications Standards Institute, 1999, the contents of which are hereby incorporated herein), at most eight MSs may be serviced in a single timeslot. As a result of the organization of bitmap 200 illustrated in FIG. 3, a BS 104, having been assigned a sub-bitmap 306 for allocation (which includes the full complement of eight timeslots), BS 104 can provide service to a maximum of sixty-four MSs during the pendency of single sub-bitmap 306 (i.e., eight MSs serviced/timeslot and eight timeslots having been allocated-assuming that there are eight timeslots in a data frame and a maximum of eight mobilestations can be serviced in any one timeslot). It should be noted that current standards dictate that only thirty-two unique identifiers are available to identify an MS 106 being serviced by a BS 104. Consequently, without modification to the current standards, a maximum of thirty-two MSs 106 can be serviced during by a BS 104 during the pendency of single bitmap 200. However, in some instances it may be desirable to modify those standards (or develop another standard) to provide service to a greater number of MSs 106.

The organization of bitmap 200 into a group of orthogonal sub-bitmaps 306 further enables tremendous flexibility in the allocation scheme employed by a BS 104. This flexibility arises due to the contiguous nature of the sub-bitmap 306. That is, many of the restraints employed in other proposed schemes for allocating those resources in a bitmap 200 have been removed.

Additionally and advantageously, MSs adapted to use resources forming part of a sub-bitmap (e.g., sub-bitmap 306A) are, during non-transmitting/non-receiving periods (i.e., the time period covered by sub-bitmaps 306B, 306C and 306D), provided with time to assess and/or measure co-channel interference ratios.

Further, using the sub-bitmap solution described herein, MSs are not required to transition from a non-transmitting/non-receiving mode into a transmitting/receiving mode (and vice versa) as often as compared to other methods (e.g., the rotational timegroup solution). Such transitions require a relatively significant expenditure of energy. As a result, MSs deployed in a network employing the sub-bitmap solution described herein are expected to have a longer battery life.

In a further advantage, embodiments of the present invention provide additional flexibility in the allocation of resources to BSs. As indicated above, a bitmap 200 can be divided or separated into sub-bitmaps 306 having different sizes. Accordingly, an MTSO 108, determining that two co-channels (that is, two cells operating using the same carrier frequency) have significantly different service loads (e.g., the first co-channel BS is servicing a relatively large number of mobiles as compared to the second co-channel BS) or demands (e.g., the first co-channel BS is receiving requests for resources form a relatively large number of mobiles as compared to the second co-channel BS), can allocate a relatively larger sized sub-bitmap 306 (i.e., a sub-bitmap having a greater number of data frames 210) to the first (and more heavily loaded) co-channel BS and a relatively smaller size sub-bitmap 306 to the second (and less heavily loaded) co-channel BS. This offers significant flexibility in allocating scarce resources to satisfy the needs of wireless users/customers.

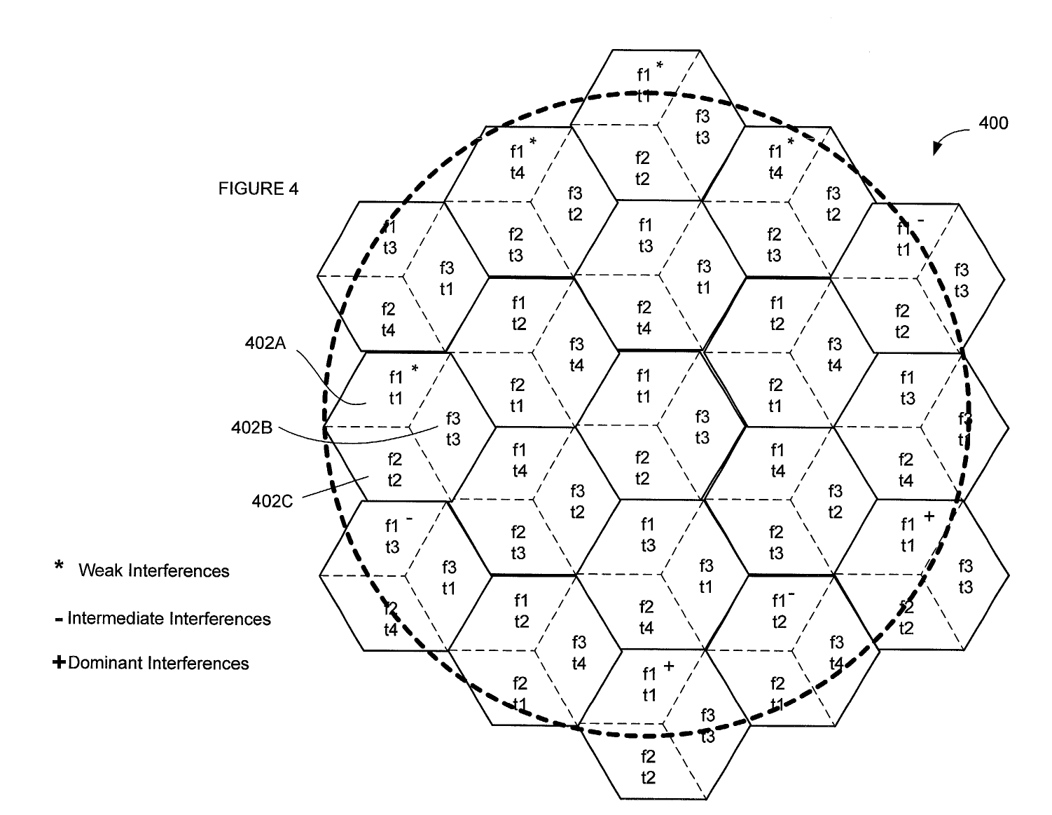

A further embodiment of the invention is illustrated in FIG. 4. Network 400 comprises numerous cells 402. Each cell 402 is separated into three sectors 402A, 402B and 402C. Each sector of cell is serviced (in the exemplary embodiment) by one of three carrier frequencies (f1, f2 and f3) employed by network 400. Service using a plurality of carrier frequencies may be enabled by use of an omni-directional antenna in each cell 402. The omni-directional antenna would need to be adapted to transmit and receive on the frequencies employed in the cell. Alternatively, one directional antenna for a given sector may be employed in each sector. Each directional antenna for given sector would be adapted to communicate on only one of the selected frequencies.

In the exemplary embodiment of FIG. 4, each bitmap 200 that is allocated to co-channel sectors (that is, sectors using the same frequency) will be divided into four sub-bitmaps 306A-D. Sub-bitmap 306A covers a first time period (t1) of the bitmap 200. Similarly, sub-bitmap 306B covers the non-overlapping time period t2, sub-bitmap 306C covers t3 and sub-bitmap 306D covers t4. Time periods t1, t2, t3 and t4 are orthogonal (i.e., they do not overlap).

As illustrated in FIG. 4, each sector of a cell 402 is assigned a sub-bitmap/frequency pair (e.g., sub-bitmap 306A—represented in FIG. 4 as t1—with frequency f1). As a result of this pairing, there are twelve possible combinations. Consequently, employing a sub-bitmap/frequency pair in a wireless network will, using the same re-use strategy, significantly increase the carrier-to-interference ratio (as compared to conventional systems). That is, for a given carrier signal strength, the interference strength is reduced.

As will be appreciated by those of ordinary skill in the art, the allocation scheme described herein could also be applied to other wireless regimes such as, for example, GSM, GPRS, E-TDMA and others.

Further, the allocation of resources described herein may be implemented in computer instructions loaded into conventional network elements (e.g., an MTSO, BS or MS) so that the network element is adapted to participate in the resource allocation scheme employing sub-bitmaps. The computer instructions may be loaded into a conventional network element by way of known media types (e.g., computer or memory chip, diskette, ROM, RAM, downloaded by way of networked communication, etc.).

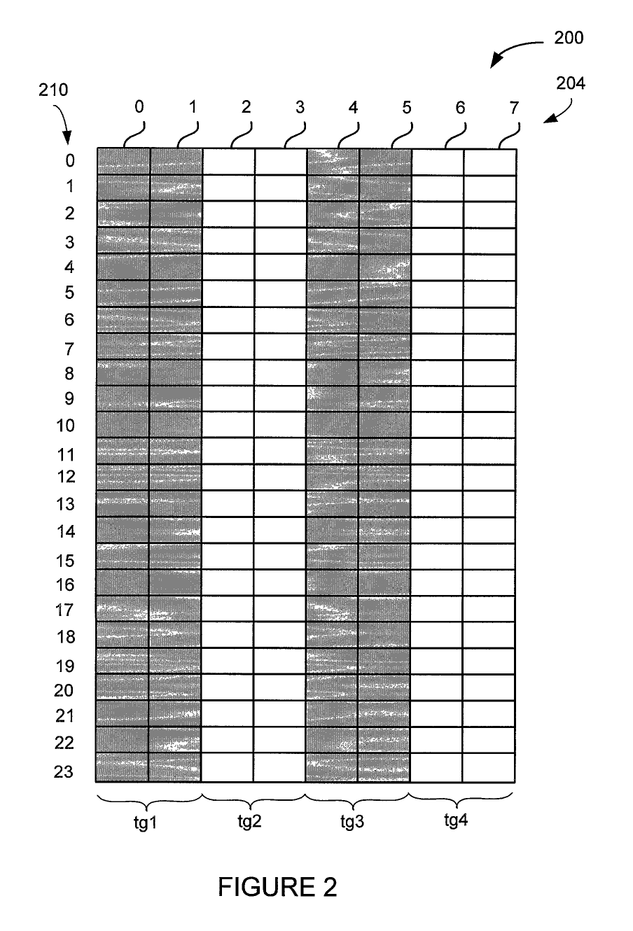

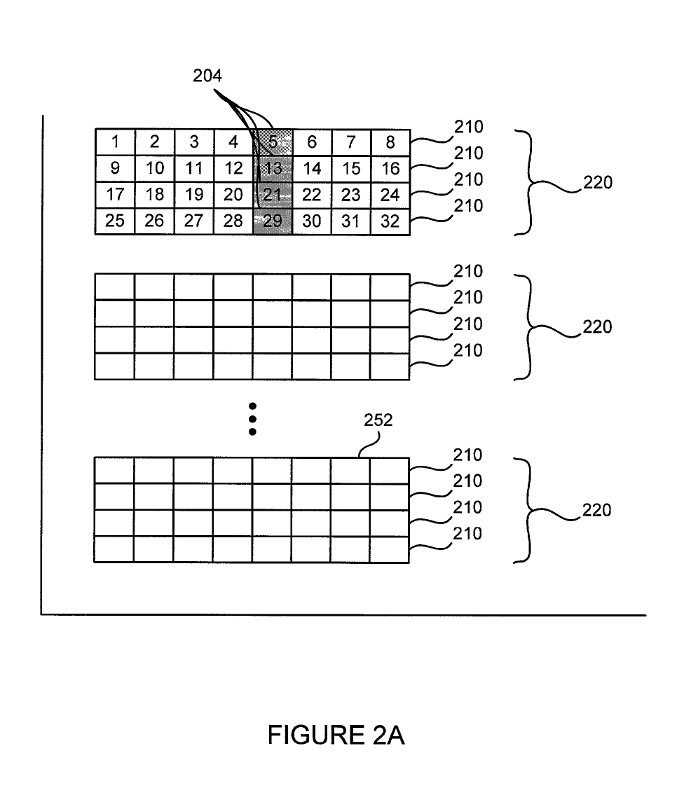

It should be noted that in an alternative embodiment bitmap 200 comprises a larger number of data frames 210. In this alternative embodiment, bitmap 200 includes ninety-six data frames 210. Four consecutive data frames 210 are logically grouped together into a frame group 220 (see FIG. 2A). A block 202 is formed from a logical group comprising one timeslot 204 in each of the four grouped data frames 210 in a frame group 220. In this alternative embodiment, a BS 104 will still be allocated an orthogonal sub-bitmap 306, but the sub-bitmap 306 will be formed of contiguous frame groups 220 and, consequently, contiguous blocks 202. A BS 106 is then free to allocate blocks 202 in the assigned sub-bitmap 306 (rather than individual timeslots as in the first embodiment).

Regardless of the types of resources allocated by BS 104 (i.e., timeslots 204 in a data frame 210 or blocks 202), the allocation scheme described herein is equally applicable.

While one (or more) embodiment(s) of this invention has been illustrated in the accompanying drawings and described above, it will be evident to those skilled in the art that changes and modifications may be made therein without departing from the invention. All such modifications or variations are believed to be within the scope of the invention as defined by the claims appended hereto.

What is claimed is:

1. A method of allocating a plurality of data frames amongst a plurality of basestations, said plurality of data frames spanning an interval of time, said method comprising:
for each of said plurality of basestations allocating a sub-set of said plurality of data frames, said sub-set being contiguous in time within said interval of time.

2. The method of claim 1 wherein each of said plurality of basestations operates using the same carrier frequency.

3. The method of claim 2 wherein said data frames are timeslots in a Time Division Multiple Access (TDMA) wireless network.

4. The method of claim 1 wherein said plurality of basestations form part of a TDMA wireless network employing at least one of the Enhanced Data rates for Global Evolution (EDGE) and EDGE Compact standards.

5. The method of claim 1 further comprising:
wherein said each of said plurality of basestations operates using a plurality of frequencies, allocating to each of said plurality of basestations a sub-set of said plurality of data frames for each of said plurality of frequencies used by a basestation, said sub-set of said plurality of data frames being contiguous in time within said interval of time.

6. A method of allocating a bitmap of resources in a wireless network amongst a plurality of co-channel basestations, said bitmap formed by a group of data frames, said method comprising:
dividing said bitmap of resources into sub-bitmaps, each of said sub-bitmaps formed by a contiguous portion of said group of data frames, each of said sub-bitmaps not overlapping in time with any other of said sub-bitmaps; and
allocating at least one of said sub-bitmaps to each of said plurality of co-channel basestations.

7. The method of claim 6 further comprising:
prior to said dividing, forming the size of each of said sub-bitmaps responsive to at least one of: service loads for each of said plurality of co-channel basestations during at least one previously allocated bitmap; and service demands for each of said plurality of co-channel basestations during at least one previously allocated bitmap.

8. A basestation in a wireless cell, said basestation comprising:
a processing circuit in communication with memory storing computer readable instructions, said computer readable instructions adapting said processing circuit to:
receive instructions indicating a time period during which said basestation may communicate with mobilestations to be serviced by said basestation, said time period defined by a contiguous set of data frames; and
transmit to each of said mobilestations to be serviced by said basestation data identifying a portion of time during which a mobilestation may communicate with said basestation; and
communicate with said mobilestations during said time period.

9. The basestation of claim 8 wherein said instructions indicating a time period during which said basestation may communicate are defined by a group of timeslots, said group of timeslots defining a sub-bitmap.

10. The basestation of claim 9 wherein said processing circuit is further adapted to:
receive instructions defining a plurality of sub-bitmaps; and
allocate each of said plurality of sub-bitmaps to a sector serviced by said basestation.

11. A method of allocating wireless network resources amongst a plurality of basestations, said wireless network resources comprising a group of data frames, said method comprising:
receiving requests for wireless network resources from said plurality of basestations;
responsive to said requests, assigning to each of said plurality of basestations a portion of said wireless resources, said portion comprising a group of said data frames, said group of said frames being contiguous in time.

12. A method for coordinating operation of a plurality of basestations, each of said basestations operating with the same carrier frequency, said method comprising:
for a given time period, allocating a contiguous portion of said given time period to each of said plurality of basestations; and
transmitting to each of said plurality basestations data identifying said contiguous portion of said given time period allocated to a basestation.

13. The method of claim 12 further comprising:
prior to said allocating, determining the service load for at least some of said plurality of basestations; and
wherein the size of said contiguous portions assigned to said each of said plurality of basestations is proportional to said service loads determined.

14. A computer readable medium operable to provide instructions for directing a processor circuit to allocate a bitmap of resources in a wireless network amongst a plurality of co-channel basestations, said bitmap formed by a group of data frames, said instructions directing said processing circuit to:
divide said bitmap of resources into sub-bitmaps, each of said sub-bitmaps formed by a contiguous portion of said group of data frames, each of said sub-bitmaps not overlapping in time with any other of said sub-bitmaps; and
allocating at least one of said sub-bitmaps to each of said plurality of co-channel basestations.

15. The computer readable medium of claim 14 further adapting said processing circuit to:
form the size of each of said sub-bitmaps responsive to at least one of: service loads for each of said plurality of co-channel basestations during at least one previously allocated bitmap; and service demands for each of said plurality of co-channel basestations during at least one previously allocated bitmap.
